(19) United States
(12) Patent Application Publication
(10) Pub. No.: US 2025/0051222 A1
(43) Pub. Date: Feb. 13, 2025

(54) Tubular composite body made of quartz glass and method for producing and using the same

(71) Applicant: Heraeus Quarzglas GmbH & Co. KG, Hanau (DE)

(72) Inventors: Walter LEHMANN, Kleinostheim (DE); Klaus-Uwe BADEKE, Bitterfeld-Wolfen (DE); Michael HÜNERMANN, Kleinostheim (DE); Martin HENGSTERMANN, Bitterfeld-Wolfen (DE)

(21) Appl. No.: 18/791,953

(22) Filed: Aug. 1, 2024

(30) Foreign Application Priority Data
Aug. 8, 2023 (EP) 23190224.8

(51) Int. Cl. C03C 17/00; C03C 17/02

(52) U.S. Cl. CPC C03C 17/005; C03C 17/02; C03C 2203/52; C03C 2217/213; C03C 2218/32

(57) ABSTRACT

A known method for producing a tubular quartz glass composite body in an outer deposition process comprises providing and rotating a substrate tube about an axis of rotation, depositing SiO₂ particles on the outer jacket surface of the tube forming a composite consisting of the tube and a SiO₂ soot body, and sintering the composite by heating to form the tubular quartz glass composite body, and using a holding device which is suitable for holding the composite body at least temporarily in the heating zone with the longitudinal axis of the substrate tube oriented vertically. To enable the production on this basis of a tubular composite body consisting of quartz glass with a particularly large inner diameter and with a wall with reduced scrap, it is proposed that a holding device is used which comprises a holding element which is produced in a holding region of the substrate tube.

### CROSS-REFERENCE TO RELATED APPLICATIONS

This application claims priority pursuant to 35 U.S.C. 119 (a) to European Application No. 23190224.8, filed Aug. 8, 2023, which application is incorporated herein by reference in its entirety.

### TECHNICAL FIELD

The present invention relates to a composite body made of quartz glass, in particular a tubular composite body made of quartz glass having a length of at least 1000 mm, a raw wall and an inner diameter of at least 250 mm.

The invention also relates to the production of a tubular quartz glass composite body, in particular a method for producing a tubular quartz glass composite body in an external deposition method, comprising the following method steps:
(a) providing a substrate tube which has a continuous through-opening running coaxially to a longitudinal axis of the substrate tube, a substrate tube outer diameter, a substrate tube inner diameter, a substrate tube outer jacket surface, a substrate tube inner jacket surface, and a substrate tube wall having a wall thickness,
(b) rotating the substrate tube about an axis of rotation running coaxially with or parallel to the longitudinal axis of the substrate tube,
(c) depositing SiO₂ particles on the outer jacket surface of the substrate tube by means of at least one deposition burner, forming a composite from the substrate tube and an SiO₂ soot body,
(d) sintering the composite body by heating at a sintering temperature in a heating zone to form the tubular quartz glass composite body, and using a holding device which is suitable for holding the composite body at least temporarily with a vertically oriented longitudinal axis of the substrate tube in the heating zone.

### BACKGROUND

Components made of quartz glass in the form of preforms, tubes, rods, flanges, plates, rings, reactors, crucibles, and the like are used in semiconductor production and for producing optical fibers. Such components are often produced from tubular semi-finished products made of quartz glass by thermally forming and/or mechanically processing them. Due to increases in productivity, larger dimensions are increasingly being sought for such components, which in particular in tubular semi-finished products, is associated with greater wall thicknesses and inner diameters.

For the production of half-finished products from synthetically produced silicon dioxide, CVD processes (chemical vapor deposition) are known, in which SiO₂ particles are deposited from the gas phase on a substrate. The CVD external deposition process known by the abbreviation “OVD” (outside vapor deposition) is generally suitable for the production of large-volume semi-finished products. In this process, a silicon-containing starting material is converted into SiO₂ particles in a reaction zone by means of flame hydrolysis or pyrolysis, and these particles are deposited in layers on the outer jacket of a cylindrical substrate rotating around its longitudinal axis. The reaction zone is generated by means of a heat source, wherein the substrate longitudinal axis and the heating source move back and forth relative to one another. The substrate can be tubular and is also referred to here and in the following as a “substrate tube.” The substrate tube consists, for example, of quartz glass, SiC, SiSiC (reaction-bonded silicon-infiltrated silicon carbide), Al₂O₃, or another ceramic material, or of graphite, and is held and rotated about its longitudinal axis by means of a lathe-like device, which is also referred to here as a “substrate tube holder.”

Depending on the temperature during the deposition process, the layer of synthetic SiO₂ deposited on the substrate tube is still porous and is also referred to below as the “soot layer” or “soot body.” or it forms a dense layer of more or less transparent quartz glass. In the case of a porous soot layer, this layer is sintered in a separate method step to form more or less transparent quartz glass (the sintering process is also referred to as “vitrification”). From the tubular quartz glass semi-finished product thus produced, a component of synthetic quartz glass is obtained by mechanical, chemical, and/or thermal post-processing, such as a solid cylinder, a hollow cylinder, or parts of these components which themselves can also serve as semi-finished products for the production of other components.

### PRIOR ART

U.S. Pat. No. 8,316,671 B2 describes an OVD external deposition method for producing a hollow cylinder made of quartz glass. A substrate tube made of quartz glass is provided, and a porous SiO₂ soot layer is deposited on its outer surface. The composite consisting of the substrate tube and SiO₂ soot layer is vitrified in such a way that the inside of the substrate tube remains below the deformation temperature. For this purpose, the inner bore of the substrate tube can be cooled by a gas or liquid during the vitrification process. The inner wall of the tubular composite body of quartz glass produced in this way is formed by the substrate tube; it is smooth and no longer needs to be mechanically processed.

US 2013/115391 A1 discloses a method for manufacturing quartz glass hollow cylinders with a large outer diameter, wherein a porous soot body made of silicon dioxide carbon black is deposited on a substrate by means of an OVD outer deposition process. After the substrate has been removed, the soot body is sintered to form a hollow cylinder. Rings are sawn from this, which are made of quartz glass with a low chlorine content and at the same time a low hydroxyl group content and therefore have a high viscosity. The quartz glass rings are used as so-called “plasma etching rings” for holding semiconductor wafers in plasma etching systems.

To vitrify the soot body, it is held in a sintering furnace in a vertical orientation or in a horizontal orientation of its longitudinal axis. If the longitudinal axis is oriented vertically, the soot body can be vitrified standing on a pedestal. However, there is a risk that the soot body will deform and collapse into itself due to its weight. This can result in the formation of a caterpillar-like structure of circumferential folds, so that the dimensional accuracy requirements cannot be met; in particular the specified minimum internal diameter can be exceeded.

The method known from EP 701 975 A2 avoids some of these disadvantages. In said method, the tubular soot body is inserted into a vitrification furnace and held therein in a vertical orientation by means of a holding device comprising a holding rod which extends from above through the inner bore of the soot body and which is connected to a holding foot on which the soot body initially rests with its lower end. The holding rod consists of carbon fiber reinforced graphite (CFC; carbon fiber reinforced carbon) and it is tightly surrounded by a gas-permeable, thin-walled sheath tube made of pure graphite. In a position above the upper end of the sheath tube, a graphite support ring is embedded in the inner bore of the soot body, which protrudes from the soot body wall inwards into the soot body inner bore.

During vitrification, the soot body is moved through an annular heating element in zones, starting with its upper end. In the process, the soot body successively collapses onto the graphite sheath tube and also shrinks in length, wherein it stands upright on the holding foot in a first sintering phase. The position of the graphite support ring embedded in the soot body is selected in such a way that it is supported on the graphite sheath tube in a second sintering phase as a result of the increasing length shrinkage so that the soot body is then held suspended at the upper end. This method is also referred to below as “suspended vitrification.” After vitrification, the sheath tube is removed, and the inner bore of the resulting quartz glass tube is reworked by drilling, grinding, honing, or etching.

To reduce the graphite contact surfaces, in a modification of this method according to DE 103 03 290 B3, a sleeve of synthetic quartz glass is provided between the holding rod and the soot body to be vitrified. The production of this sleeve is very time-consuming and expensive, and it is or becomes part of the quartz glass tube.

In the method known from DE 100 64 730 A. SiO₂ particles are deposited on an elongated substrate tube rotating around its longitudinal axis, which has a gradation of its outer diameter over its length. After removal of the stepped substrate tube, a porous, hollow cylindrical soot body is obtained, the inner bore of which has a complementary shape corresponding to the outer diameter profile of the substrate tube, i.e. it has a stepped shoulder. The soot body thus obtained is vitrified suspended in a vertical orientation in a furnace, wherein the narrowed region of the inner bore is arranged at the top, and a holding rod projecting from above into the inner bore engages below the step-shaped shoulder. Reliable holding of a heavy soot body requires a relatively wide shoulder on the inner bore.

### Technical Problem

With increasingly larger quartz glass cylinders, the weight of the soot bodies to be sintered and the increasing temperature differences between the inside and outside make the manufacturing process more difficult. With the methods described above, it is hard to reliably hold heavy soot bodies during vitrification and to reproducibly manufacture tubes from quartz glass. In particular, scrap in a late stage of the method, such as when vitrifying the soot body, is to be avoided.

Similar problems also arise when vitrifying other bodies made of porous SiO₂ that were not produced via the SiO₂ soot route, such as porous SiO₂ bodies which were obtained via the known sol-gel route or by pressing.

### SUMMARY

The invention is therefore based on the object of presenting a method for manufacturing such large-volume, tubular composite bodies from quartz glass by means of an outer deposition process, in particular by means of an OVD deposition welding process.

Furthermore, the invention is based upon the object of presenting a method for reproducibly manufacturing a tubular composite body made of quartz glass with a large internal diameter according to the outer deposition process, in particular with an internal diameter of more than 200 mm and with a wall thickness of more than 25 mm, which avoids the above-mentioned disadvantages and in which, in particular, the risk of scrap is reduced.

In addition, the invention is based on the object of providing a tubular quartz glass composite body which is characterized on the one hand by large dimensions, in particular by an internal diameter of more than 200 mm, a wall thickness of more than 25 mm and a length of at least 1000 mm, and at the same time by high dimensional stability.

### GENERAL DESCRIPTION OF THE INVENTION

With regard to the method for producing the tubular composite body made of quartz glass, this object is achieved according to the invention on the basis of a method of the type mentioned at the beginning in that a holding device is used which comprises a holding element which is produced in a holding region of the substrate tube in a shaping step.

The method comprises a method step in which a porous SiO₂ soot body, which is also referred to as “soot body” for short in the following, is produced from synthetic silicon dioxide by means of an outer deposition method, in particular by means of an OVD outer deposition method. The porous SiO₂ soot body can optionally be subjected to a dehydration treatment in inert gas, chlorine-containing gas, or under a vacuum to reduce the hydroxyl group content of the quartz glass before it is sintered to form the more or less transparent quartz glass. The sintering (or vitrification) takes place, for example, under vacuum or in an atmosphere containing helium and/or hydrogen and/or nitrogen.

The substrate tube is designed to produce the SiO₂ body on its outer jacket surface with a large inner diameter on the basis of the external deposition method. The substrate tube has, for example, a substrate tube length up to 4 m and is cylindrical, conical, or stepped over its entire length or over part of its length. The inner contour is constant over the length of the substrate tube, or it changes.

After completion of the deposition process, the substrate tube remains in the composite consisting of the substrate tube and soot body, and becomes part of the tubular quartz glass composite body to be produced (hereinafter also referred to as “quartz glass composite body” or “composite body” for short). It consists of quartz glass and preferably has an inner diameter of at least 250 mm. Its wall thickness is preferably in the range of 4 mm to 10 mm and is therefore small in relation to its outer diameter. The wall thickness is usually less than 20% of the outer diameter of the substrate tube. On the one hand, the substrate tube thus has a low weight, which reduces the dynamics of the rotational movement and facilitates handling and alignment, and on the other it has a low thermal mass, which keeps the heat dissipation and the formation of thermal stresses within the wall low.

On the other hand, the wall thickness of the substrate tube is large enough to support a large-volume SiO₂ soot body. Therefore, the wall thickness of the substrate tube is preferably at least 1% of the outer diameter of the substrate tube. The wall thickness “W_{S}” (in mm) can also depend upon the length of the substrate tube. It is advantageous if the wall thickness also increases with increasing length of the substrate tube. Therefore, WS can alternatively be set as a function of the outer diameter D_{S} of the substrate tube (in mm), additionally taking into consideration the length of the substrate tube “L_{S}” (in mm), as follows: W_{S}<0.2*(L_{S}/2,000 mm)*D_{S}.

After completion of the external deposition method and the optional dehydration treatment of the soot body, the sintering (vitrification) of the soot body takes place according to process step (d), in the form of a composite consisting of substrate tube and SiO₂ soot body, i.e. connected to the substrate tube. The substrate tube used for this purpose is characterized by the fact that it has a holding element that is produced in a holding area of the substrate tube in a shaping step.

The holding element forms a part of the holding device during the sintering of the composite body. It is designed, for example, as a local constriction of the through-holes, or of the inner diameter of the substrate tube, or as a local widening of the outer diameter of the substrate tube. During sintering, it serves to realize a suspension of the composite body and, in doing, so interacts with a support element of the holding device. The support element is, for example, a sheath tube that is arranged inside the substrate tube during sintering and onto which the composite body collapses during sintering. The holding element rests on the support element at least temporarily during sintering so that a suspended vitrification of the composite body is enabled.

In contrast to the prior art, the invention does not require a separate body to be connected to the inner bore of the soot body that can serve as a suspension. Damage and contamination of the soot body can occur during the production of the connection. This is avoided in the invention in that the substrate tube, which is required anyway in the outer deposition method, is vitrified together with the soot body in the form of the composite body, and during this, the substrate tube is used as part of the suspension.

For this purpose, in a shaping step, the holding element is produced in a holding area of the substrate tube.

The holding area is usually located in the area of one of the end faces of the substrate tube. These end face areas can be essentially free of SiO₂ soot particles after the soot deposition process. However, they can also be covered by the ends of the forming SiO₂ soot body.

The shaping step for producing the holding element can take place before the sintering (vitrification) according to method step (d).

With regard to a previously generated holding element, a first preferred method variant provides that the holding element is generated prior to the deposition of the SiO₂ particles according to method step (c), wherein the deposition of the SiO₂ particles according to method step (c) is preferably carried out in such a way that the SiO₂ soot body covers the holding area.

In this method variant, the holding element is produced by shaping an already-existing substrate tube. In so doing, the substrate tube wall is heated and softened locally, for example, and is collapsed to form an indentation in the wall or is inflated to form an expansion, such as a local bulge. Or the holding element is formed for example by the shaping process during the manufacture of the substrate tube, such as by creating a constriction of the inner bore of the substrate tube during a drawing process in which the substrate tube is drawn from a melt, or in which a mother tube is elongated to form the substrate tube.

This production step can be carried out easily, and the holding element thus obtained can be checked for completeness and dimensional accuracy.

During the subsequent deposition process, the holding element produced in advance is covered by the soot body that forms. The holding element is thereby protected from thermal and mechanical effects. It is sufficient here if the overlap takes place only in the region of one of the end faces of the soot body. The soot body ends usually form tapered areas that cannot be used for the production of the final quartz glass body. However, this measure is not absolutely necessary; the previously generated holding element can also lie completely outside the soot body.

Alternatively or in addition to this and equally preferably, the shaping step for generating the holding element takes place in a sintering phase during sintering according to method step (d); the holding element is generated more or less “in situ” during vitrification.

With regard to a holding element produced during sintering, in a second preferred method variant, the holding element is produced after the deposition of the SiO₂ particles according to method step (c) and before or during sintering according to method step (d).

The holding element can be formed in the sintering furnace in a single operation with the sintering of the composite body. A separate manufacturing and hot-forming step and the associated costs can thus be avoided.

In both the first and second method variants, it has proven advantageous if the holding element is designed as a constriction of the inner diameter of the substrate tube.

This constriction of the inner diameter of the substrate is produced when the forming step is carried out and is designed, for example, as a local circumferential indentation in the region of the inner jacket surface of the substrate tube wall, or as a gradual, for example, conical tapering of the inner diameter of the substrate tube.

The constriction of the inner diameter of the substrate tube acts as a holding element during sintering for the suspended holding of the composite body. It is preferably made as small as possible to minimize the degree of deformation of the substrate tube and as large as necessary to ensure that the weight of the composite body is reliably accommodated. Advantageously, the constriction has a longitudinal extension in the direction of the longitudinal axis of the substrate tube in the range of 20 to 200 mm, preferably in the range of 30 to 100 mm.

The substrate tube inner diameter can be constant or can vary over this length of the constriction. In this context, it has proven useful if the constriction brings about a maximum reduction of the inner diameter of the substrate in the range of 4 mm to 80 mm, preferably in the range of 6 mm to 50 mm.

In a particularly preferred method, the constriction is designed as a local indentation of the inner jacket surface of the substrate tube and/or as a tapering of the substrate tube through-opening in the holding area.

Here it has proven useful if the taper of the substrate tube through-opening is produced during sintering according to method step (d) by softening an upper substrate tube end together with a shaped body placed thereon, against which the upper substrate tube end rests, and bending the upper substrate tube end inward under the influence of the weight of the shaped body.

The taper of the substrate tube through-opening in the holding area takes place stepwise, continuously, and preferably conically, in that the upper substrate tube end softens and is bent inward under the action of the weight of a shaped body.

In a further, also preferred case, a shaped body which has an inner cone on which the upper substrate tube end rests is placed onto the upper substrate tube end. The shaped body and the upper substrate tube end resting thereon are heated in the zone sintering furnace, thereby softening the upper substrate tube end. Under the weight of the shaped body, the outer jacket surface of the substrate tube in the area of the upper end is shaped to form an outer cone, and the inner jacket surface of the substrate tube is shaped to form an inner cone.

Both in the first and in the second method variant, it has also proven advantageous if the holding element is designed as an expansion of the outer diameter of the substrate tube.

The expansion of the outer diameter forms for example a circumferential bulge in the holding area of the substrate tube.

This expansion of the outer diameter of the substrate tube is produced when the forming step is carried out and is designed, for example, as a local circumferential bulge in the area of the outer jacket surface of the substrate tube wall, or as a gradual, for example, conical expansion of the outer diameter of the substrate tube.

The expansion of the outer diameter of the substrate tube acts as a holding element during sintering for the suspended holding of the composite body. It is preferably made as small as possible to minimize the degree of deformation of the substrate tube and as large as necessary to ensure that the weight of the composite body is reliably accepted. The substrate tube outer diameter can be constant or can vary over this length of the expansion.

Advantageously, the expansion has a longitudinal extension in the direction of the longitudinal axis of the substrate tube in the range of 20 to 200 mm, preferably in the range of 30 to 100 mm.

In this context, it has proven useful if the expansion brings about a maximum enlargement of the outer diameter of the substrate tube in the range of 4 mm to 80 mm, preferably in the range of 6 mm to 50 mm.

The expansion is preferably produced during sintering according to method step (d) by softening an upper substrate tube end together with an expansion device, which has an expansion body that can move radially outward and rests against the inner wall in the area of the upper substrate tube end, and moving the expansion body radially outward under the influence of the weight of the expansion device, and deforming the substrate tube wall in the area of the upper substrate tube end while forming the bulge.

In a particularly preferred method, a substrate tube is provided that is made at least partly of quartz glass of a first quartz glass quality, wherein the soot body consists of quartz glass of a second quartz glass quality, and wherein the first quartz glass quality has a material-specific viscosity at the sintering temperature which is higher than the material-specific viscosity of the second quartz glass quality.

The substrate tube used is characterized by high thermal stability, so that while the soot body is sintered, it becomes less soft than the soot body. The thermally more stable substrate tube not only gives the softening soot body a certain hold so that it achieves or retains the desired cylindrical shape, it also forms a particularly thermally stable holding element.

The comparatively higher viscosity of the substrate tube is achieved, for example, by the fact that over at least part of its length and/or at least over a thickness region of its wall, it consists of a quartz glass which has a higher viscosity at the sintering temperature than the synthetic quartz glass of the soot body. In the simplest and preferred case, the substrate tube consists entirely of the quartz glass of the first quartz glass quality, i.e. the higher-viscosity quartz glass. In another, equally preferred embodiment, the quartz glass of the substrate tube consists only over a portion of its length of a higher-viscosity quartz glass, for example in the part of its length which is used as a holding element during sintering of the soot body.

During sintering, the composite body is softened zone by zone starting with its upper end, wherein it preferably stands on a pedestal in a first sintering phase. The position of the holding element is selected so that it is supported on a support element of the holding device in a second sintering phase as a result of the increasing length shrinkage, such as on a sheath tube that is arranged in the through-holes of the substrate tube. In the second sintering phase, the composite body is held suspended at its upper end. In this case, the holding element is no longer in the hottest area of the heating zone and has therefore already cooled down enough to take over the suspended holding of the composite body. This is helped if the substrate tube consists entirely, or at least in the area of the holding element, of a quartz glass of the first quality which is characterized by a comparatively high viscosity.

The sintering temperature is typically in the range of 1200° C. to 1450° C. It has proved useful if, at a measurement temperature of 1350° C., the common logarithm of the viscosity of the first quartz glass quality is at least 0.25 log (dPa·s), preferably at least 0.4 log (dPa·s) and particularly preferably at least 0.6 log (dPa·s) higher than that of the quartz glass of the second quartz glass quality. The viscosity differences are indicated here as the difference between the common logarithm log (dPa·s) of the corresponding viscosity values. Viscosity differences greater than 1 log (dPa·s) at the measurement temperature are generally not required.

The viscosity of quartz glass can be changed by stiffening its glass network structure and in particular by dopants. Stiffening of the glass network structure can be achieved by oxygen deficiency centers (also known as ODC centers). Nitrogen, titanium oxide, and aluminum oxide are dopants which are suitable for increasing the viscosity of quartz glass. In view of this, a preferred method provides that the quartz glass of the first quartz glass quality has a content of aluminum oxide which is at least 5 ppm by weight, preferably at least 10 ppm by weight, higher than the content of aluminum oxide in the quartz glass of the second quartz glass quality. Therefore, for the purpose of increasing the viscosity, aluminum oxide can be added to a quartz glass that is designed for components that are used at high temperature and that are intended to have a certain temperature stability. The viscosity of synthetically produced quartz glass can also be increased in this way.

Naturally occurring raw material for quartz glass often contains a certain proportion of aluminum oxide. In view of this, the quartz glass of the first quartz glass quality is preferably melted from a naturally occurring raw material. The costs of manufacturing the substrate tube from natural quartz glass are comparatively low. For example, such substrate tubes can be produced cost-effectively using the known crucible drawing method.

The quartz glass of the second quartz glass quality is, for example, highly pure, synthetically produced quartz glass without a significant proportion of aluminum oxide or with a low proportion of aluminum oxide of less than 1 ppm by weight, preferably less than 0.5 ppm by weight.

In contrast, the quartz glass of the first quartz glass quality preferably contains at least 5 ppm by weight, preferably at least 10 ppm by weight. However, an aluminum oxide content of more than 100 ppm by weight is generally not preferred.

The viscosity of quartz glass can also be altered by hydroxyl groups. Hydroxyl groups can lower the viscosity of quartz glass. In view of this, a preferred method provides that the quartz glass of the first quartz glass quality has a hydroxyl group content of less than 30 ppm by weight and preferably a hydroxyl group content of less than 20 ppm by weight.

Hydroxyl group contents of less than 30 ppm by weight can be achieved in a quartz glass quality produced from natural raw material, for example by melting the raw material in an electrically heated furnace or by using a hydrogen-free plasma. The hydroxyl group content of quartz glass produced synthetically via the SiO₂ soot route is adjustable within wide limits by drying the soot body before vitrification. As a result of this drying treatment, low hydroxyl group contents in the range of a few ppm by weight, which are characterized by a comparatively low viscosity, can also be achieved in synthetically produced quartz glass. Optionally, synthetic quartz glass with a low hydroxyl group content is suitable as a substrate tube material, provided that the quartz glass of the soot body applied thereon has a comparatively low viscosity.

In a preferred method, a substrate tube is used which has a wall thickness in the range of 1.5 mm to 10 mm, preferably in the range of 4 to 8 mm.

The wall thickness is as large as necessary to ensure the desired thermal stability. On the other hand, the wall thickness is as small as possible, since the material of the substrate tube is usually removed during further processing of the quartz glass composite body.

The tubular quartz glass composite body obtained after vitrification of this composite consisting of the substrate tube and SiO₂ soot layer has an inner wall region consisting of the quartz glass of the first quality which originates from the former substrate tube. And it has an outer wall region consisting of the quartz glass of the second quality, which results from the former soot body. The thickness of the outer wall region scales with the wall thickness of the soot body and the soot density.

The soot density is typically in the range of 25 to 33% of the density of quartz glass. In view of this, the soot body obtained according to the external deposition method is advantageously substantially cylindrical and preferably has a wall thickness which, after the sintering of the composite body, results in a glass layer which has a layer thickness in the range of 25 mm to 100 mm, preferably in the range of 30 mm to 60 mm.

With regard to the tubular quartz glass composite body, the technical object stated above, starting from a composite body of the type mentioned at the outset, is achieved according to the invention in that the tube wall has an inner wall region and an outer wall region, wherein the inner wall region comprises a holding element which is designed as a constriction of the inner diameter of the substrate tube or as an expansion of the outer diameter of the substrate tube.

The tubular quartz glass composite body can be produced using the method according to the invention explained above. The outer wall region of the quartz glass composite body is optionally formed of quartz glass that has been obtained by sintering a former soot body, and the inner wall region is formed by the quartz glass of the former substrate tube.

The inner wall region comprises a holding element which, during the sintering process, enables a suspended vitrification to form the quartz glass composite body. This suspended vitrification ensures high dimensional stability in the resulting quartz glass composite body according to the invention.

The constriction of the holding element is realized, for example, as a circumferential indentation or as a regional conical taper of the inner diameter of the substrate tube. The expansion is designed for example as a circumferential bulge or as a regional conical expansion of the outer diameter of the substrate tube.

The holding element is characterized by particularly high dimensional stability during the sintering process if the inner wall region consists at least partially of quartz glass of a first quartz glass quality, and the outer wall region consists of quartz glass of a second quartz glass quality, wherein at a measuring temperature of 1350° C. the viscosity of the first quartz glass quality is higher than the viscosity of the second quartz glass quality.

A quartz glass hollow cylinder is produced from the quartz glass composite body by removing the inner wall region, for example by drilling, milling, or etching. The quartz glass hollow cylinder obtained in this way is used to produce etching rings for single-wafer plasma etching chambers or pressure vessels for use in chemical engineering.

The etching rings or pressure vessels have a specified target inner diameter. For the production of the etching rings or pressure vessels, a composite body is preferably used having an outer wall region having an inner diameter which is smaller by at least 1 mm than the target inner diameter. The target inner diameter is set here by removing the entire inner wall region and an allowance on the outer wall region, where the allowance is 1 mm or more.

### Definitions and Measurement Methods

Individual terms of the above description are further defined below. The definitions are part of the description of the invention. For terms and measuring methods that are not specifically defined in the description, the interpretation according to the International Telecommunication Union (ITU) is relevant. In the event of an inconsistency between one of the following definitions and the rest of the description, the statements made in the description take precedence.

### Tubular Composite Body Consisting of Quartz Glass

The result of the deposition process is a tubular composite consisting of a quartz glass substrate tube and a SiO₂ soot body. The substrate tube delimits the inner bore of the composite. By sintering (vitrification) of the soot body, a tubular composite body made of quartz glass is obtained. A quartz glass hollow cylinder is obtained by subsequently removing the substrate tube from the quartz glass composite body. The substrate tube is removed for example by being drilled out. Mechanical, thermal or chemical processing is used to produce components of quartz glass from the quartz glass hollow cylinder. Further mechanical processing includes drilling, sawing, cutting, milling, grinding, and polishing the inner and outer contours. Thermal further processing includes thermal drying, sintering, vitrification, melting, forming, and tempering. The further chemical processing includes doping and etching. The component consisting of quartz glass is a ready-to-use quartz glass product or a semi-finished product therefor, for example a quartz glass hollow cylinder for producing a pressure vessel or a quartz glass ring or a quartz glass ring for producing a holding ring for wafers.

### Quartz Glass/Synthetic Quartz Glass

Quartz glass is understood here to mean glass with an SiO₂ content of at least 87 wt %. It is doped (SiO₂ content=100%) or contains dopants such as fluorine, chlorine, nitrogen, carbon, or oxides of boron, germanium, rare earth metals, aluminum, or titanium.

Quartz glass is, for example, a melted product from naturally occurring SiO₂ raw material (natural quartz glass), or it is synthetically produced (synthetic quartz glass), or consists of mixtures of these quartz glass types.

### Sintering/Vitrification

“Sintering” or “vitrification” here denotes a method step in which a soot body of porous silicon dioxide is treated in an furnace at high temperature. Sintering/vitrification takes place in inert gas, an atmosphere containing hydrogen and/or helium, or under vacuum.

### Vacuum

The vitrification of the composite body can be carried out under a vacuum. The negative pressure is indicated as an absolute gas pressure. Vacuum means an absolute gas pressure of less than 50 mbar.

### Substrate Tube Outer Diameter/Substrate Tube Inner Diameter

The substrate tube cross-section has a circular outer contour or an outer contour that deviates from the round shape. If the outer contour deviates from the round shape, the local “outer diameter value” is given by the diameter of the (smallest) circumference.

The substrate tube cross-section has a circular inner contour or an inner contour deviating from the round shape. If the inner contour deviates from the round shape, the local “inner diameter value” is given by the diameter of the (largest) inscribed circle.

In the longitudinal section of the substrate tube, the local values for the outside diameter are constant or not constant over the entire length of the substrate tube. In the case of constant outer diameter values, the substrate tube has a cylindrical shape, seen from the outside. The non-constant outer diameter values can vary over the total length or over a partial length. The outer contour can change continuously or gradually, for example. In this case, the outer diameter results from the local outer diameter values averaged over the total length.

In the longitudinal section of the substrate tube, the local values for the outside diameter are constant or not constant over the entire length of the substrate tube. In the case of constant inner diameter values, the through-opening of the substrate tube is cylindrical. The non-constant inner diameter values can vary over the total length or over a partial length. The inner contour can change continuously or gradually, for example. In this case, the inner diameter results from the local inner diameter values averaged over the total length.

### Viscosity

The viscosity of the quartz glass is measured using a beam bending viscometer. Beam bending viscometry covers a viscosity range from 10⁸ to 10¹⁵ dPa·s. The measurement setup comprises a heatable three-point bending device with a measuring beam consisting of the quartz glass to be measured (beam/strip: 50 mm long, 3 mm high, 5 mm wide). The measured variable is the bending speed at the given temperature.

Instead of exponential notation, viscosity values are often also specified using the common logarithm in the form log (dPa·s).

### Softening Temperature

Glasses cannot be assigned a specific softening temperature, but rather a softening temperature range. In order to determine a temperature value, reference is made here to the determination according to DIN ISO 7884 (1998), according to which the softening temperature is defined as the temperature at which the glass has a viscosity of 10^{7.6} dPa·s. For the softening temperature of undoped quartz glass, temperature values in the range of 1600° C. to 1730° C. are mentioned in the literature.

### BRIEF DESCRIPTION

The invention is explained in more detail below with reference to exemplary embodiments and a patent drawing. In detail, in a schematic representation:

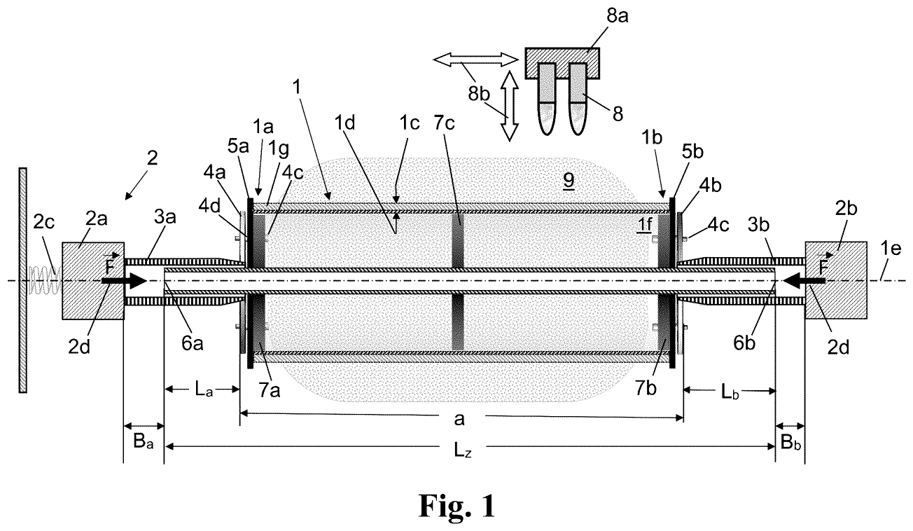

FIG. 1 shows a device for producing a composite body consisting of a substrate tube and soot body in a first embodiment of a substrate tube holder, in a longitudinal section,

FIG. 2 shows a device for producing a composite body consisting of substrate tube and soot body in a second embodiment of a substrate tube holder in a longitudinal section, partly as a detail, and

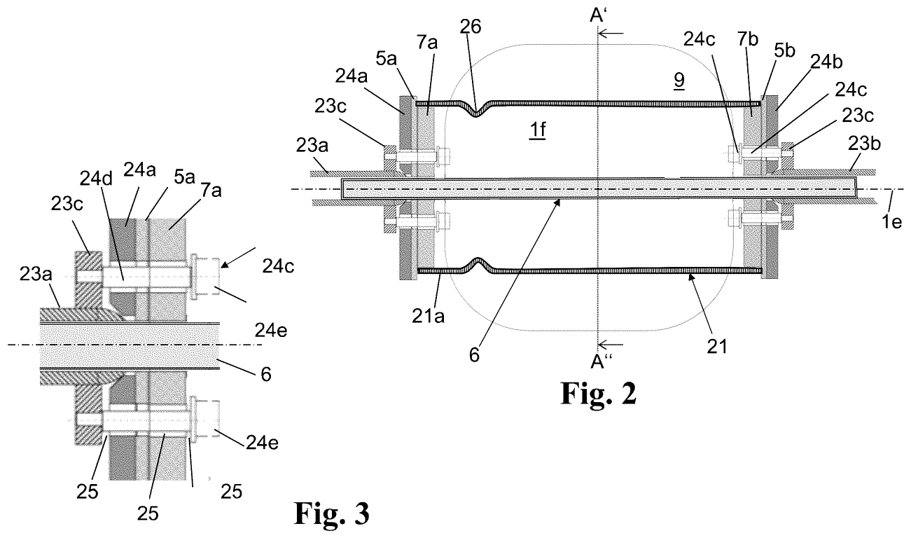

FIG. 3 shows a detail of the substrate tube holder of FIG. 2 in an enlarged view,

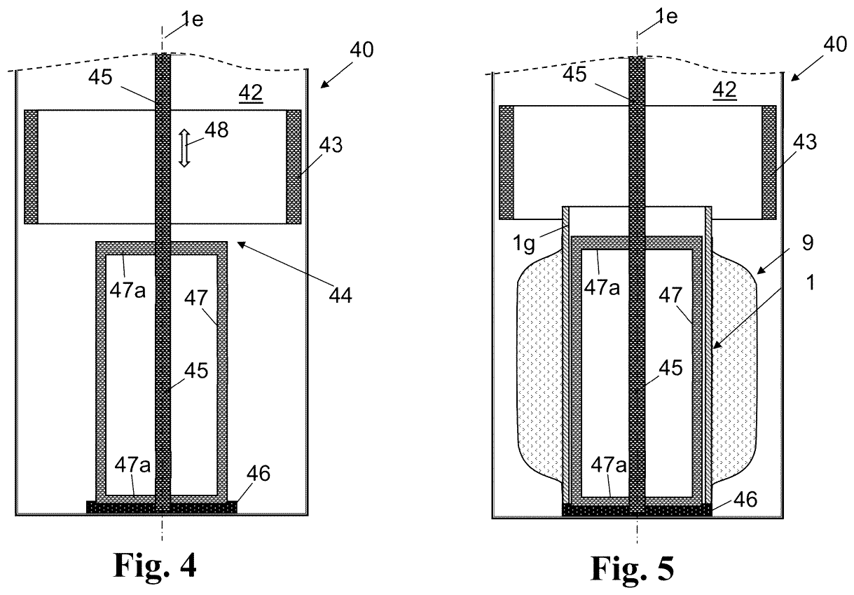

FIG. 4 shows components of a zone sintering furnace as used for vitrification of a composite body,

FIG. 5 shows the vitrification of a standing composite body using the zone sintering furnace,

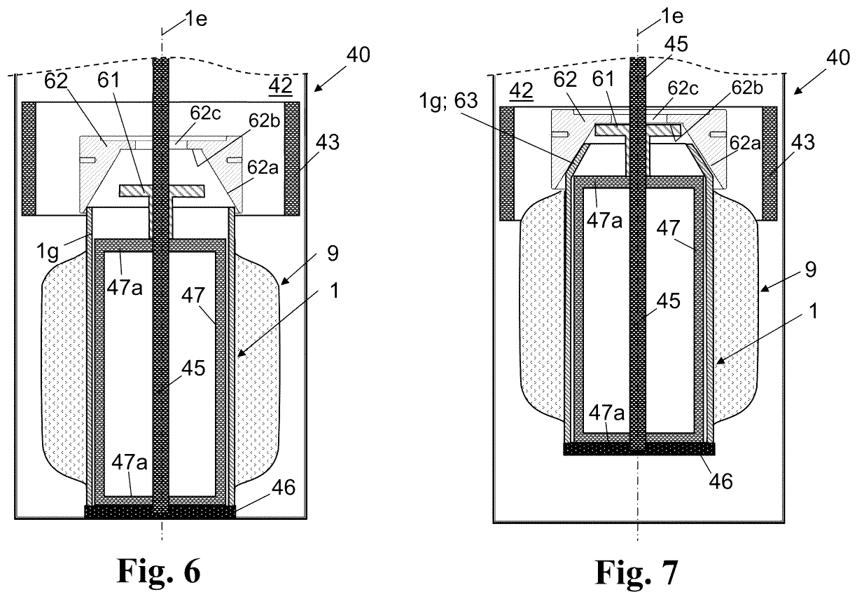

FIG. 6 shows a method step for producing a first embodiment of a retaining edge on the substrate tube,

FIG. 7 shows a further method step for producing the retaining edge on the substrate tube,

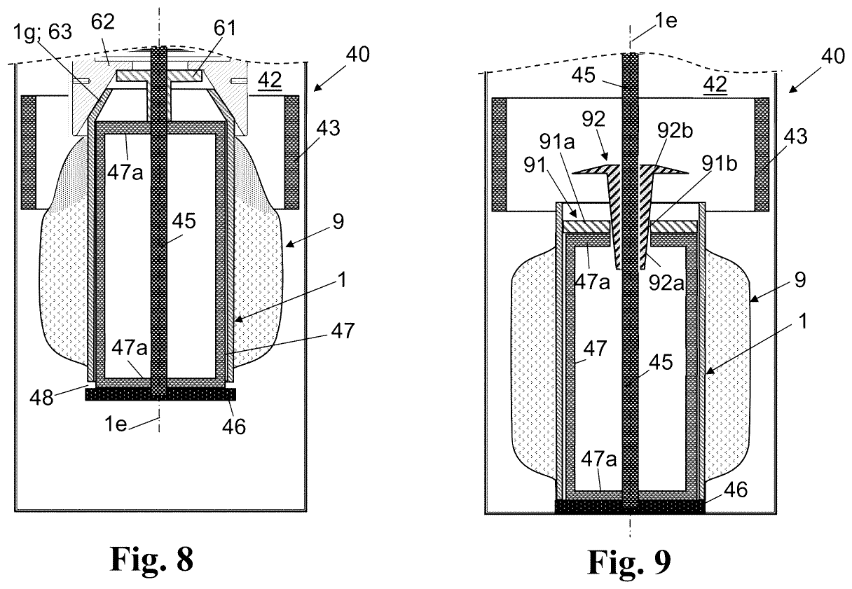

FIG. 8 shows the vitrification of a partially suspended composite body by means of the first embodiment of the retaining edge on the substrate tube in the zone sintering oven,

FIG. 9 shows a method step for producing a second embodiment of a retaining edge on the substrate tube,

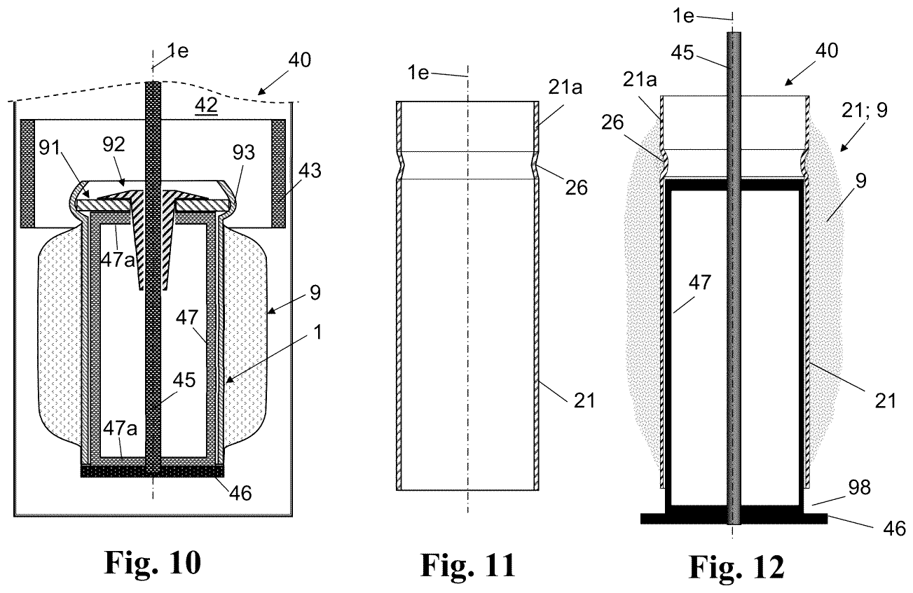

FIG. 10 shows a further method step for producing the retaining edge on the substrate tube,

FIG. 11 shows an embodiment of a substrate tube with a retaining edge produced before the outer deposition process in the form of a taper of its inner diameter,

FIG. 12 shows the substrate tube of FIG. 11 after completion of the external deposition process during vitrification of the composite body in the zone sintering furnace of FIG. 4,

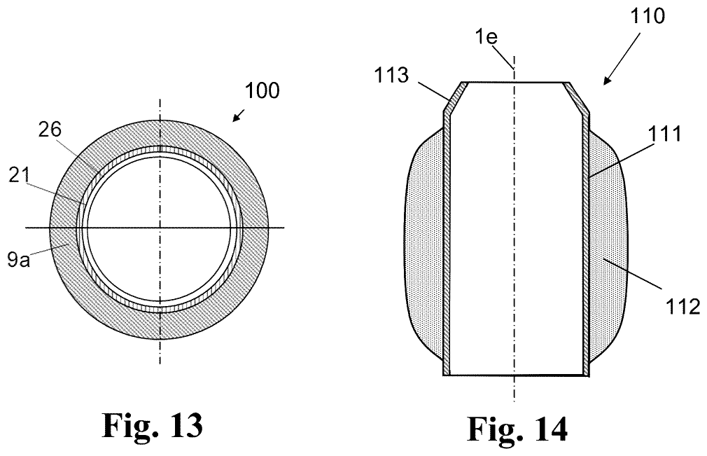

FIG. 13 shows a first embodiment of a tubular quartz glass composite body according to the invention in a longitudinal section, and

FIG. 14 shows a second embodiment of a tubular quartz glass composite body according to the invention in a longitudinal section.

### DETAIL DESCRIPTION

In the embodiments explained below, different substrate tubes are used, of which some properties are summarized in Table 1.

TABLE 1
Substrate tubes

| | | Viscosity | Outside | Inside | | |
|---|---|---|---|---|---|---|
| | | [log(dPa · s) at | diameter | diameter | Length | |
| No. | Material | 1350° C.] | [mm] | [mm] | [mm] | Mold |
| 1 | Natural quartz glass | 11.28 | 280 | 270 | 2000 | Cylinder |
| | (electro-fused) | | | | | |
| 2 | Natural quartz glass | 11.28 | 280 | 270 | 1500 | Cylinder with |
| | (electro-fused) | | | | | constriction |
| 3 | Synthetic quartz glass | 10.77 | 280 | 270 | 1500 | Cylinder with |
| | (thermally dried) | | | | | constriction |
| 4 | Synthetic quartz glass | 10.64 | 280 | 270 | 1500 | Cylinder with |
| | (dried with chlorine) | | | | | constriction |

“Natural quartz glass” is melted from naturally occurring SiO₂ raw material, preferably in an electrically heated melting furnace. The substrate tube consisting of natural quartz glass is produced particularly cost-effectively using a vertical crucible drawing method. This quartz glass typically contains aluminum oxide in a concentration in the range of between 6 ppm by weight and 18 ppm by weight, and hydroxyl groups in a concentration of less than 50 ppm by weight.

“Synthetic quartz glass” is obtained for example by flame hydrolysis or oxidation of synthetically produced silicon compounds, by polycondensation of organic silicon compounds according to what is referred to as the sol-gel method, or by hydrolysis and precipitation of inorganic silicon compounds in a liquid. The viscosity of synthetic quartz glass depends on its composition, which can vary over a wide range. However, it can very generally be said that synthetic quartz glass typically has a significantly lower viscosity than natural quartz glass.

The device shown schematically in FIG. 1 is used to produce a large-volume composite consisting of a substrate tube 1 and an SiO₂ soot body 9. It comprises a glass lathe 2 for holding and rotating the substrate tube 1 corresponding to number 1 in Table 1. The substrate tube 1 has a left end face 1a, a right end face 1b, an outer jacket surface 1c, an inner jacket surface 1d, a horizontally-oriented longitudinal axis 1e, and a cylindrical through-hole 1f. Adjacent to the end face 1a is a free substrate tube section 1g on which a reduced deposition of SiO₂ soot particles takes place during the soot deposition process. The free substrate tube section 1g can be formed into a retaining edge during vitrification, which is explained in more detail below with reference to FIGS. 4 and 6 to 10.

The glass lathe 2 is indicated by two, oppositely-situated chucks 2a, 2b, of which the chuck 2a is spring-loaded, as indicated by the compression spring 2c. The compression spring 2c generates a pressure force F that presses the two chucks 2a, 2b against each other, as indicated by the directional arrows 2d.

A hollow spindle 3a. 3b made of stainless steel is clamped in each of the chucks 2a, 2b at their proximal ends. In the ideal case, the axes of rotation of the hollow spindles 3a, 3b run coaxially to the substrate tube longitudinal axis 1e. The hollow spindles 3a, 3b have an outer diameter of 90 mm and an inner diameter of 82 mm.

The distal ends of the hollow spindles 3a, 3b are pivotably connected to an annular pressure plate 4a, 4b made of stainless steel. For this purpose, the distal ends of the hollow spindles 3a, 3b taper conically and, as a result of the force of the spring 2c, press against the corresponding pressure plate 4a, 4b. Here, the conical end protrudes into a center bore of the respective annular pressure plate 4a, 4b and abuts the inner edge of the center bore.

The pressure plates 4a, 4b each abut buffer disks 5a, 5b made of graphite, which in turn abut the substrate tube end faces 1a and 1b respectively. The buffer disks 5a, 5b have a central bore whose diameter corresponds to that of the pressure plates and which run coaxially to these. The pressure plates 4a. 4b have an outer diameter that is 10 mm smaller than the outer diameter of the substrate tube 1. The buffer disks 5a, 5b have an outer diameter that extends beyond the outer diameter of the substrate tube 1 by 40 mm.

A tubular centering support 6 made of SiSiC with a total length L_{z} and an outer diameter of 80 mm extends through the substrate tube through-hole 1f and through the center bores of pressure plates 4a. 4b and buffer disks 5a, 5b. One end 6a of the centering support 6 projects into the hollow spindle 3a over a length La of 500 mm and ends inside it, leaving a variable movement clearance Ba of approximately 6 mm. The other end 6b protrudes into the hollow spindle 3b over a length Lb of 600 mm and ends inside it, leaving a variable movement clearance Bb also of about 6 mm. The entire movement clearance B_{z}=Bₐ+B_{b} for the centering support 6 within the hollow spindles 3a, 3b is thus 12 mm. The outer diameter of the centering support 6 is constant over its length and is adapted with a clearance fit to the inner diameter of the hollow spindles 3a, 3b and telescopically displaceable therein.

Three centering rings 7a, 7b, 7c made of graphite are placed on the centering support 6. The centering ring 7a is located in the area of the left substrate tube end face 1a, the centering ring 7b is located in the area of the right substrate tube end face 1b, and the centering ring 7c is located approximately in the middle of the substrate tube through-hole 1f. All centering rings 7a, 7b, 7c have an outer diameter that is matched to the inner diameter of the substrate tube with a clearance fit, and they have an inner diameter that is matched to the outer diameter of the centering support with a clearance fit.

The end centering ring 7a, the buffer disk 5a, and the pressure disk 4a are loosely connected to each other by means of screws 4c. The screws 4c have a thread which adjoins a cylinder portion 4d. The screw thread engages in each case in an internal thread in the pressure disk 4a, so that the cylinder portion 4d lies firmly against the pressure disk 4a in the tightened state. The length of the cylinder portion 4d is greater than the total thickness of the component stack of centering ring 7a and buffer disk Sa, so that the heads of the screws 4c do not rest against the centering ring 7a, but a gap remains between the centering ring 7a and the screw heads. Furthermore, the through-holes for the passage of the cylindrical section 4d in the buffer disk 5a and in the centering ring 7a are greater than the diameter of the cylinder section 4d, so that the screws 4c can also be slightly inclined in the through-holes. This loose connection is therefore suitable both for allowing thermally-induced changes in length between components of the substrate tube holder and for compensating for deviations in the target dimensions, positioning, and alignment of the components. In addition, the screws 4c provide a certain torsional strength between the buffer disk 5a and the pressure disk 4a during the rotational movement of the substrate tube 1, and, in this respect, serve as driving elements for this rotational movement. The same applies to the connection of the centering ring 7b, the buffer disk 5b, and the pressure disk 4b. A gap is provided between the centering ring 7a, 7b and the buffer disk 5a, 5b for the purpose of thermal decoupling (not visible in the figure).

Several deposition burners 8 for generating SiO₂ particles are mounted on a common slide 8a, by means of which they can be moved reversibly and transversely along the outer jacket surface 1c of the substrate tube 1 or along a forming SiO₂ soot body 9, and can be displaced perpendicularly thereto, as indicated by the directional arrows 8b.

When the same reference numerals are used in FIG. 2 and in FIG. 3 as in FIG. 1, these designate identical or equivalent components or components of the device.

The device shown schematically in FIG. 2 differs from that of FIG. 1 essentially in terms of the substrate tube holder and the substrate tube 21. When the same reference numbers are used as in FIG. 1, these denote identical or equivalent components or parts of the device explained with reference to FIG. 1.

Substrate tube 21 corresponds to number 2 in Table 1. In an end region 21a, it has a circumferential constriction 26 of its inner diameter. The constriction 26 is produced before the start of the outer deposition process, for example by local softening of the substrate tube 21 after being clamped in the glass lathe 2. The constriction 26 is located at a distance of approximately 80 mm before the substrate tube end face. The inner diameter is 270 mm, except in the region of the constriction 26, where it is 250 mm.

The hollow spindles 23a, 23b, which are each clamped in clamping chucks with their proximal end, are made of stainless steel. In the ideal case, the axes of rotation of the hollow spindles 23a, 23b run coaxially to the substrate tube longitudinal axis 1e. The hollow spindles 23a, 23b have an outer diameter of 100 mm. A circumferential extension arm 2c is welded in each case in the region of the distal ends of the hollow spindles 23a, 23b.

The pivoting connection between the hollow spindles 23a. 23b and the corresponding pressure plates 24a, 24 is designed here as a floating bearing and preferably comprises a cardan ball cone seat. Here, the distal ends of the hollow spindles 23a. 23b each form a convexly-curved seat which has a spherical or radius section on which the pressure plate 24a or the pressure plate 24b is movably mounted by having a concavely-curved spherical or radius section cooperating with the convexly-curved seat.

FIG. 3 shows an enlarged view of the pivoting connection between the hollow spindles 23a. 23b and the respective pressure plates 24a. 24b. The end centering ring 7a, the buffer washer 5a, and the pressure disk 24a form a stack of components that are loosely connected to each other by means of threaded screws 24c, each of which engages in a thread in the extension arm 23c. The cylindrical portion 24d has a length which is greater than the total thickness of the component stack consisting of centering ring 7a, buffer disk 5a, and pressure disk 24a. In addition, the width of the bore for receiving the threaded screws 24c in the component stack is significantly larger than the diameter of the cylinder portion 24d. This leads to several gaps 25 remaining both between the screw head 24e and the centering ring 7a and between the pressure plate 24 and the extension arm 23c, even with a fixedly-tightened threaded screw 24c, and along the cylinder portion 24d. The gaps 25 ensure that the connection between the hollow spindles 23a, 23b and the corresponding pressure plates 24a. 24b remains pivotable. At the same time, the screws 24c serve as driver elements for the rotational movement of the substrate tube 1.

Examples for producing a quartz glass composite body are explained below with reference to FIGS. 1 and 4 to 10.

### Soot Deposition Process

Oxygen and hydrogen are supplied to the deposition burners 8 as burner gases, and a gas stream containing SiCl₄ or another silicon-containing starting material is supplied as feed material for the formation of SiO₂ particles. These components are converted into SiO₂ particles in the relevant burner flame, and these SiO₂ particles are deposited on the substrate tube 1 rotating around the longitudinal axis 1e, forming the soot body 9 from porous SiO₂ soot.

To rotate the substrate tube 1, the glass lathe 2 transmits a torque to the hollow spindles 2a, 2b. At the same time, a pressure force F acting in the axial direction is generated by means of the compression spring 2c which presses the two hollow spindles 3a, 3b against one another and which, depending upon the deflection of the spring from the spring rest length, is in the range between 0.5 kN and 10 kN. The initially set pressure force F is 1 kN and is applied to the pressure plates 4a, 4b, the buffer disks 5a, 5b, and thus also to the substrate tube end faces 1a, 1b. This pressure force F creates a frictional connection between the buffer disks 5a, 5b, which is sufficient to hold the inherent weight of the substrate tube 1 and the weight of the soot body 9. The centering rings 7a, 7b, 7c are used only to prevent the substrate tube 1 from slipping or bending unexpectedly. A certain amount of axial guidance is provided by the interaction of hollow spindles 3a, 3b and centering support 6, which, due to the mechanical play present, compensates for any radial offsets and angular differences between the axes of rotation of the hollow spindles 3a, 3b, and avoids mechanical stresses.

The deposition process is terminated as soon as the soot body 9 has reached a predetermined outer diameter which, depending on the density of the soot layer, leads to the predetermined outer diameter of the hollow cylindrical quartz glass composite body, plus an allowance of 1 mm. At a soot density of about 30% (relative to the density of quartz glass) and a target external diameter of the quartz glass composite body of 362 mm, the soot body outer diameter is, for example, approximately 520 mm.

After the deposition process, the soot body 9 is substantially barrel-shaped and extends up to just before the ends of the substrate tube 1 on both sides. The substrate tube section 1g, which protrudes from the soot body 9 and is only slightly covered by SiO₂ soot, has a length of about 100 mm.

### Drying and Vitrification Process

The substrate tube 1 remains in the soot body 9. The composite (1; 9) consisting of the substrate tube 1 and soot body 9 is subjected to a dehydration treatment in a drying furnace in an inert gas atmosphere, a halogen-containing atmosphere, or under a vacuum. The drying of the soot body 9 here takes place thermally, by heating to a temperature around 1100° C. in a nitrogen atmosphere. By vitrifying the resulting dried SiO₂ soot body under vacuum, a synthetic quartz glass with the following properties is obtained:
Hydroxyl group content: about 200 ppm by weight.
Chlorine content: <0.2 ppm by weight
Viscosity at 1350° C.: 10.77 log (dPa·s).

### Vitrification

The subsequent vitrification of the soot body 9 takes place in a zone sintering furnace with a vertically oriented substrate tube longitudinal axis 1e under a vacuum or in an atmosphere of gases that diffuse quickly in quartz glass, such as helium and hydrogen, and therefore do not cause bubbles. FIG. 4 schematically shows a detail of such a zone sintering furnace 40. The furnace chamber 41 encloses a furnace interior 42 in which an annular heating element 43 and a holding device 44 are located. This device comprises a support rod 45 made of fiber-reinforced carbon, which is connected by its lower end to a pedestal 46 of graphite. The upper end of the support rod 45 is held by means of a movable gripper (not shown in the figure), and can be moved up and down thereby. The support rod 45 extends through the annular opening of the heating element 43 and through a sheath tube 47 of graphite which stands on the pedestal 46. Apart from the passages for the support rod 45, the sheath tube end faces are closed. In comparison to a sheath tube that is open on both sides, the largely closed upper and lower side 47a give the sheath tube 47 a higher dimensional rigidity relative to the pressure acting from the outside.

During the vitrification, the substrate tube 1 remains in the soot body 9. The holding device 44 is used to hold the composite (1; 9) consisting of the substrate tube 1 and soot body 9, the weight of which over the pedestal 46 is supported by the support rod 45. As shown schematically in FIG. 5, the substrate tube 1 surrounds the sheath tube 47. Its outer diameter is adapted to the inner diameter of the substrate tube 1 in such a way that the annular gap remaining during sintering is as small as possible, taking into account the higher thermal expansion coefficient of the graphite sheath tube 47 compared to the quartz glass substrate tube, and is, for example, in the range of 1 mm to 10 mm, preferably less than 5 mm.

During vitrification, the heating element 43 is heated to a temperature of around 1400° C., and the support rod 45 is continuously pulled upwards so that the soot body 9 is vitrified from top to bottom. During this, the composite (1; 9) shrinks onto the sheath tube 47 so that its outer diameter defines a lower limit for the inner diameter of the vitrified, tubular quartz glass composite body. The substrate tube 1 consists of natural quartz glass which has a higher viscosity at the sintering temperature than the synthetic quartz glass of the soot body 9. At a measuring temperature of 1350° C., according to Table 1, the viscosity difference corresponding to the difference between the common logarithms of the respective viscosity values is about 0.51 log (dPa·s) [11.28 log (dPa·s)−10.77 log (dPa·s)].

The substrate tube 1 is thus comparatively thermally stable and does not deform or slightly deforms. In this way, it produces a stabilization of the soot body 9 during vitrification. In particular, the risk is counteracted of the soot body 9 collapsing during vitrification and forming circumferential folds, or of the inner diameter expanding which results in scrap.

After cooling, a tubular composite body consisting of the substrate tube 1 and a glass layer is obtained with a thickness of about 41 mm, which has been obtained by vitrifying the soot body 9. Despite the shrinking of the synthetic quartz glass onto the inner graphite sheath tube 47, said glass can be easily removed after vitrification since graphite has a significantly higher coefficient of thermal expansion than quartz glass and contracts more during cooling.

The quartz glass of the substrate tube 1 can then be removed by mechanical processing, for example by drilling. After grinding off and smoothing the outer wall, a quartz glass hollow cylinder having an outer diameter of 360 mm and an internal diameter of 290 mm is obtained.

### Comparative Example

As explained above, due to its comparatively high viscosity the substrate tube 1 contributes to the shape stabilization of the soot body 9 during vitrification.

In order to investigate the effect of the substrate tube 1 on the shape stabilization of the soot body 9, in a first comparative experiment, the substrate tube was removed before vitrification, and only the soot body 9 was vitrified in the zone sintering furnace 40 starting from the top downward. In so doing, the soot body 9 collapses under its own weight, and the vitrified region detaches from the sheath tube 47, which leads to a local widening of the inner diameter. The quartz glass tube produced in this way was unusable.

In a further comparative experiment, a substrate tube of synthetic quartz glass was used having the same dimensions as the substrate tube 1, as specified under number 3 of Table 1. The viscosity of this quartz glass is lower than the viscosity of the quartz glass obtained by vitrification of the soot body 9. It has been found that when this composite body is used, the sheath tube imparts better adhesion to the vitrified soot body 9 so that detachment over a large area of the vitrified material did not occur. However, the continuously increasing weight of the vitrified upper region of the composite body resulted in compression toward the end of the process, so that the quartz glass tube produced in this way was also ultimately unusable.

In a further comparative experiment, a substrate tube consisting of synthetic quartz glass with the same dimensions as substrate tube 1 was used, as specified in number 4 of Table 1. The viscosity of this quartz glass corresponds to the viscosity of the quartz glass that is obtained by vitrification of the soot body 9. However, here as well, during sintering of the composite (1; 9), it was shown that there was compression toward the end of the process so that the quartz glass tube produced in this way was also ultimately unusable.

### Suspended Vitrification

To counteract the effect of compression from intrinsic weight, a vitrification method is often used in which the composite (1; 9) does not stand up permanently on the pedestal 46 during vitrification, but is held suspended at least temporarily. This method, which is known for example from EP 0 701 975 B1, is referred to here for short as “suspended vitrification.”

It is thereby ensured that the composite (1; 9) is either kept suspended from the beginning in the vitrification furnace, or the holding of the composite (1; 9) during the vitrification process can transition from standing at the beginning of the vitrification to suspended holding as soon as the unavoidable axial sintering shrinkage becomes noticeable. To implement the suspended holding, measures can be taken on the substrate tube even before the outer deposition method is carried out. This can take place for example by shaping a substrate tube, or by the shaping process during the manufacture of the substrate tube, such as by producing a constriction of the inner bore of the substrate tube during a drawing process in which the substrate tube is drawn from a melt, or in which a mother tube is elongated to form the substrate tube. Alternatively or in addition, and equally preferably, these measures are generated “in situ” during vitrification.

A suitable measure for realizing suspended vitrification is the formation of a retaining edge on the substrate tube which serves to ensure that the composite (1; 9) is vitrified while suspended vertically (and not exclusively standing) at least some of the time. As a result of the at least temporary suspended holding, in addition to the above-explained effect of the thermally stable substrate tube 1, a compression of the soot body 9 during vitrification is counteracted so that it retains its desired geometry, and scrap is avoided.

For the suspension of the composite (1; 9), for example the substrate tube section 1g can be reshaped to form a retaining edge during vitrification of the soot body 9. Suitable methods for producing the retaining edge “in situ” are explained in more detail below with reference to FIGS. 6 to 10.

FIG. 6 schematically shows a first method and a device for producing the suspension “in situ.” The composite (1; 9) consisting of the substrate tube 1 and soot body 9 is placed in the vitrification furnace 40 and supported on the platform 46, with the soot body longitudinal axis 1e oriented vertically, by means of a support rod 45 and sheath tube 47. An annular spacer 61 is placed on the upper end face 47a of the sheath tube 47, and a conical body 62 in the form of an inverted cup is placed on the upper end of the substrate tube 9. The spacer 61 and the conical body 62 consist of graphite. The conical body 62 has an inner cone 62a which merges into a flat support surface 62b in which there is a through-opening 62c. In the initial state, the inner cone 62 rests against the outer side of the upper substrate tube section 1g. The support rod 45 extends through the through-opening 62c and through the annular spacer 61.

The upper substrate tube section 1g is shaped to form a suspension during the vitrification process. The shaping process is shown schematically in FIG. 7. By means of the support rod 45, the upper substrate tube section 1g is moved into the heating element 43, which is heated to vitrification temperature, far enough that it softens. Due to its weight, the cone body 62 presses the soft upper substrate tube section 1g inward in the direction of the substrate tube longitudinal axis 1e. In so doing, the substrate tube section 1g rests against the inner cone 62a and is thereby reshaped to form an outer cone. The reshaping process is terminated as soon as the spacer 61 comes to rest against the support surface 62b of the cone body 62.

During further vitrification, the composite body (1;9) is heated zone by zone, starting with its upper end. In so doing, the composite (1; 9) collapses successively onto the graphite sheath tube 47 and also shrinks in length. The sintering shrinkage forces are strong enough here for the length of substrate tube 1 to also be shortened. However, the length shortening is small.

In a first vitrification phase, the composite (1; 9) stands on the platform 46. FIG. 8 schematically shows a second vitrification phase. During this, the former substrate tube section 1g, which has been formed into an outer cone, moves out of the heating area of the heating element 43, cools down, and solidifies. It rests by its inner side on the upper side of the sheath tube 47a and then acts as a suspension 63 for the composite (1; 9). As a result of the length shrinkage, said composite lifts off the platform 46, forming a narrow gap 48, which then enables the further “suspended vitrification.” This counteracts a collapsing of the soot body 9, wherein the substrate tube 47 additionally stabilizes the shape of the resulting tubular quartz glass composite body due to its higher viscosity.

FIG. 9 schematically shows a second method and a device for producing the suspension in situ, i.e. in one operation with the vitrification of the composite (1; 9) consisting of the substrate tube 1 and soot body 9. This is placed in the vitrification furnace 40 and supported on the platform 46, with the soot body longitudinal axis 1e oriented vertically, by means of the support rod 45 and sheath tube 47. A circular ring 91 is placed on the upper end face 47a of the sheath tube 47 and is composed of two or more separate circular sector plates 91a, 91b, which adjoin a circular ring center opening 91b and which are mounted so as to be movable in the radial direction. A conical body 92 consisting of graphite, which has a conical shaft 92a and a conical head 92b with a flat underside, projects into the center opening 91b from above. The circular ring 91 and conical body 92 consist of graphite. The outer diameter of the circular ring 91 corresponds approximately to the inner diameter of the substrate tube 1; it lies against the inner wall of the upper substrate tube portion 1g. The diameter profile of the cone shaft 92a is designed so that, in the initial state, it is inserted approximately halfway into the center opening 91b.

During further vitrification of the composite body (1; 9), the bulge 93 moves into the area above the heating element 43, cools down and solidifies. The composite body (1, 9) is heated zone by zone starting at its upper end, as described above for the first method. In a first vitrification phase, the composite (1; 9) stands on the pedestal 46, and during the second vitrification phase, the bulge 93 acts as a holder for the “suspended vitrification.” The circular sector plates 91a protrude from the inside into the bulge 93 and are fixed therein in a vertical direction together with the substrate tube 1.

The length and inner diameter of the quartz glass composite body thus obtained are predefined by the substrate tube 1. The former soot body forms a layer of transparent synthetic quartz glass with a layer thickness of 41 mm. After the removal of the quartz glass material of the substrate tube 1 and grinding off and smoothing the outer wall, a quartz glass tube having an outer diameter of 360 mm and an internal diameter of 290 mm is obtained. From this, etching rings can be cut for single-wafer plasma etching chambers and pressure vessels for use in chemical engineering.

To produce the etching ring or the pressure vessel, a composite body is preferably used having an outer wall region having an inner diameter which is smaller by at least 1 mm than the target inner diameter. The target inner diameter can be set by mechanical or chemical processing of the composite body inner bore.

In the following, a further exemplary embodiment for the realization of a retaining edge for the suspended vitrification of the composite body (21, 9) is explained with reference to FIGS. 2 and 3 and FIGS. 11 to 13.

### Soot Deposition Process

The soot deposition process is conducted as explained above with reference to FIG. 1. FIG. 11 shows the substrate tube 21 used in this process in a longitudinal section. The previously produced constriction 26 is provided in the end region 21a. As can be seen in FIG. 2, the soot body 9 is produced in such a way that it completely covers the constriction 26. However, this measure is not absolutely necessary; the constriction can also lie completely outside the soot body 9.

The deposition process is terminated as soon as the soot body 9 has reached a specified outer diameter: at a soot density of 30% (based on the density of quartz glass) and a target outer diameter of the quartz glass composite body of 362 mm, the soot body outer diameter is approximately 520 mm.

The composite (21; 9) present after the soot deposition process is subjected to a dehydration treatment in a chlorine-containing atmosphere at a temperature of 1200° C. By vitrifying the resulting dried SiO₂ soot body under vacuum, a synthetic quartz glass with the following properties is obtained:
Hydroxyl group content: <0.2 ppm by weight
Chlorine content: about 1,000 ppm by weight
Viscosity at 1350° C.: 10.64 log (dPa·s)

The composite (21; 9) is then vitrified under a vacuum in the zone sintering furnace 40. FIG. 12 shows the composite (21; 9) placed in the zone sintering furnace 40. During vitrification, the heating element 43 is heated to a vitrification temperature of around 1400° C., and the support rod 45 is continuously pulled upwards so that the soot body 9 is vitrified from top to bottom. During this, the composite (21; 9) shrinks onto the graphite sheath tube 47 so that its outer diameter defines a lower limit for the inner diameter of the vitrified, quartz glass composite body. Since the substrate tube 21 consists of a quartz glass which has a higher viscosity at the vitrification temperature than the quartz glass of the soot body 9, it does not deform or deforms only slightly, and brings about stabilization of the soot body 9 during vitrification. In particular, this counteracts the risk of the soot body 9 collapsing during vitrification and forming circumferential folds, or of expansions of the inner diameter arising.

At the shown stage of the method, the vitrification process is already advanced, and a certain shrinkage of the soot body 9 has already taken place. This means that the transition from the initial vitrification phase with a standing composite (21; 9) to “suspended vitrification” is already complete. Due to the shrinkage of the soot body 9, the length of the substrate tube 21 has also shortened a little, and it has already been lifted somewhat from the pedestal 46, forming the gap 98.

In an alternative method, the composite (21; 9) is held suspended in the zone sintering furnace from the outset by the fact that the constriction 26 rests on the upper edge of the graphite sheath tube 47.

After cooling, a composite body 100 (FIG. 13) consisting of the substrate tube 21 and a glass layer 9a with a thickness of about 41 mm is obtained, which was obtained as a result of the vitrification of the soot body 9.

In a comparative experiment, a substrate tube consisting of synthetic quartz glass was used having the same dimensions as the substrate tube 21, as specified under number 3 of Table 1. The viscosity of this quartz glass is higher than the viscosity of the quartz glass that is obtained by vitrification of the soot body 9. More precisely, the common logarithm of the viscosity of this quartz glass at a measuring temperature of 1350° C. is higher by 0.13 log (dPa·s) than the common logarithm of the viscosity of the quartz glass obtained by vitrification of the soot body 9.

However, it turns out that this difference in viscosity is too small to impart sufficient stability to the large-volume and heavy substrate tube when sintering the composite body.

FIG. 13 shows a cross-section of the composite body 100 obtained after vitrification in a view along the line A′-A″ drawn in FIG. 2. Shown are the substrate tube 1 with the through-holes 1f, the diameter constriction 26, and the layer 9a of synthetic quartz glass obtained after vitrification.

After the removal of the quartz glass material of the substrate tube 21 and grinding off and smoothing the outer wall, a quartz glass hollow cylinder having an outer diameter of 360 mm and an internal diameter of 290 mm is obtained.

Etching rings with the corresponding inner and outer diameter values for use in holding semiconductor wafers in single-wafer plasma etching chambers or pressure vessels for industrial use can be sawn therefrom.

FIG. 14 schematically shows a longitudinal section of another tubular composite body 110 obtained after cooling. This has an inner wall layer 111 which consists of the former substrate tube 1 and it has a glass layer 112 with a thickness of about 41 mm which was obtained by vitrifying the former soot body 9. The inner wall layer 111 shows a holding element 113 which, in the exemplary embodiment, is realized as a taper of the substrate tube (FIG. 8, reference numeral 1).

After the removal of the quartz glass material of the substrate tube 1 and grinding off and smoothing the outer wall, a fully synthetic quartz glass hollow cylinder having an outer diameter of 360 mm and an internal diameter of 290 mm is obtained. Etching rings with the corresponding inner and outer diameter values, or with larger inner and smaller outer diameter values, for use in holding semiconductor wafers in single-wafer plasma etching chambers and pressure vessels consisting of quartz glass for use in chemical engineering can be sawn therefrom.

What is claimed is:

1. A method for producing a tubular quartz glass composite body in an external deposition method, comprising the following method steps:
(a) providing a substrate tube which has a continuous through-opening running coaxially to a longitudinal axis of the substrate tube, a substrate tube outer diameter, a substrate tube inner diameter, a substrate tube outer jacket surface, a substrate tube inner jacket surface, and a substrate tube wall having a wall thickness;
(b) rotating the substrate tube about an axis of rotation running coaxially with or parallel to the longitudinal axis of the substrate tube;
(c) depositing SiO₂ particles on the outer jacket surface of the substrate tube by means of at least one deposition burner, forming a composite (1/9; 21/9) from the substrate tube and an SiO₂ soot body; and,
(d) sintering the composite (1/9; 21/9) by heating at a sintering temperature in a heating zone to form the tubular quartz glass composite body (100; 110) and using a holding device which is suitable for holding the composite body at least temporarily with a vertically oriented longitudinal axis of the substrate tube in the heating zone;
wherein a holding device is used which comprises a holding element which is produced in a forming step in a holding area of the substrate tube.

2. The method according to claim 1, wherein the holding element is produced prior to the deposition of the SiO₂ particles according to method step (c), wherein the deposition of the SiO₂ particles according to method step (c) is preferably carried out in such a way that the SiO₂ soot body covers the holding area.

3. The method according to claim 1, wherein the holding element is produced after the deposition of the SiO₂ particles according to method step (c) and before or during the sintering according to method step (d).

4. The method according to claim 1, wherein the holding element is realized as a constriction of the inner diameter of the substrate tube or as an expansion of the outer diameter of the substrate tube.

5. The method according to claim 4, wherein the constriction of the substrate tube inner diameter has a longitudinal extension in the direction of the substrate tube longitudinal axis in the range from 20 to 200 mm, preferably in the range from 30 to 100 mm, wherein the constriction preferably brings about a maximum reduction in the substrate tube inner diameter in the range from 4 mm to 80 mm, preferably in the range from 6 mm to 50 mm.

6. The method according to claim 4, wherein the constriction is designed as a local indentation of the inner jacket surface of the substrate tube and/or as a taper of the substrate tube through-opening in the holding area.

7. The method according to claim 6, wherein the taper of the substrate tube through-opening is produced during sintering according to method step (d) by softening an upper substrate tube end together with a shaped body placed thereon, against which the upper substrate tube end rests, and bending the upper substrate tube end inward under the influence of the weight of the shaped body.

8. The method according to claim 4, wherein the expansion of the outer diameter of the substrate tube has a longitudinal extension in the direction of the longitudinal axis of the substrate tube in the range of 20 to 200 mm, preferably in the range of 30 to 100 mm.

9. The method according to claim 4, wherein the expansion brings about a maximum enlargement of the outer diameter of the substrate tube in the range of 4 mm to 80 mm, preferably in the range of 6 mm to 50 mm.

10. The method according to claim 4, wherein the expansion is preferably produced during sintering according to method step (d) by softening an upper substrate tube end together with an expansion device, which has an expansion body that can move radially outward and rests against the inner wall in the region of the upper substrate tube end, and moving the expansion body radially outward under the influence of the weight of the expansion device, and deforming the substrate tube wall in the area of the upper substrate tube end while forming the bulge.

11. The method according to claim 1, wherein a substrate tube is provided that consists at least partly of quartz glass of a first quartz glass quality, and that the soot body consists of quartz glass of a second quartz glass quality, wherein the first quartz glass quality has a material-specific viscosity at the sintering temperature which is higher than the material-specific viscosity of the second quartz glass quality.

12. The method according to claim 11, wherein at a measurement temperature of 1350° C., the common logarithm of the viscosity of the first quartz glass quality is at least 0.25 log (dPa·s), preferably at least 0.4 log (dPa·s) and particularly preferably at least 0.6 log (dPa·s) higher than that of the quartz glass of the second quartz glass quality.

13. A tubular composite body consisting of quartz glass, with a length of at least 1000 mm, a tube wall with a wall thickness of at least 25 mm and with an inner diameter of at least 250 mm, wherein the tube wall has an inner wall region and an outer wall region, wherein the inner wall region comprises a holding element which is designed as a constriction of the substrate tube inner diameter or as an expansion of the substrate tube outer diameter.

14. The tubular composite body consisting of quartz glass according to claim 13, wherein the inner wall region consists at least partly of quartz glass of a first quartz glass quality, and the outer wall region consists of quartz glass of a second quartz glass quality, wherein at a measuring temperature of 1350° C., the viscosity of the first quartz glass quality is higher than the viscosity of the second quartz glass quality.

15. A use of the tubular composite body according to claim 13 for producing etching rings for semiconductor manufacturing or a pressure vessel, wherein a quartz glass hollow cylinder is produced by removing the inner wall region, and this cylinder is processed to form the etching rings or the pressure vessel.

16. The method according to claim 5, wherein the constriction is designed as a local indentation of the inner jacket surface of the substrate tube and/or as a taper of the substrate tube through-opening in the holding area.

17. A use of the tubular composite body according to claim 14 for producing etching rings for semiconductor manufacturing or a pressure vessel, wherein a quartz glass hollow cylinder is produced by removing the inner wall region, and this cylinder is processed to form the etching rings or the pressure vessel.
